(19) United States
(12) Patent Application Publication
(10) Pub. No.: US 2002/0102326 A1
(43) Pub. Date: Aug. 1, 2002

(54) Corn tortillas with improved texture retention using an enzyme blend in nixtamalized corn flour

(76) Inventors: Manuel J. Rubio, Miami Beach, FL (US); Roberto Contreras, Guadalupe (MX); Marco A. Baez, Centro. Queretaro (MX)

Correspondence Address: YOUNG & THOMPSON, 745 SOUTH 23RD STREET 2ND FLOOR, ARLINGTON, VA, 22202

(21) Appl. No.: 09/729,196

(22) Filed: Dec. 5, 2000

(51) Int. Cl. A21D 2/00

(52) U.S. Cl. 426/18; 426/549; 426/21

(57) ABSTRACT

Corn masa dough texture and tortilla flexibility are improved by adding to the nixtamalized corn flour, an enzyme blend comprising commercial hemicellulase and/or cellulase. The enzyme preparation has a positive effect on dough texture and improvement in tortilla elasticity and ductility during commercial storage. The combination of the enzyme blend and the method for dough and tortilla preparation can enhance conventional additives to delay corn tortilla hardening during storage.

### BACKGROUND OF THE INVENTION

1. Field of the Invention

This invention relates to a method for improving the Theological properties of a corn masa dough, and improving the texture retention of corn tortillas produced therefrom.

2. Description of Related Art

High-quality masa flour can be produced by conventional techniques only if the food-grade dent corn has the following characteristics: uniformity in kernel size and hardness, low stress-cracks and kernel damage and ease of pericarp removal during the lime-water cooking process. Nixtamalized corn flour (NCF) is produced by alkaline cooking of corn, washing, grinding the nixtamal and drying to give corn masa flour. This flour is sieved and blended for different product applications and it is usually supplemented with additives before packaging for commercial table tortilla and snack production. MASECA is the main brand of NCF in the US and Latin America, followed by Minsa, Agroinsa, Illinois Cereal Mills (Cargill) and Quaker Oats (Sustain, 1997). Although the pericarp is partially removed during the alkaline-cooking and washing process stages, there is still fiber left from the corn kernel (U.S. Pat. No. 4,513,018: Montemayor & Rubio, 1983). Unlike whole wheat, in which soluble fiber amounts to 11% of the total fiber, the corn soluble fiber is negligible (1%).

According to Watson (1987), the corn pericarp makes up 5-6% of the kernel dry weight. It also contains 67% hemicellulose, 23% cellulose and 0.6% soluble-fiber. Primary cell walls from the aleurone and starchy endosperm (83% dry weight) consist predominantly of arabinoxylan, β-glucan and some cellulose. It is estimated that mainly insoluble fiber in the pericarp and endosperm make up 78% of the total dietary fiber (9.5% in the kernel dry-weight).

Arabinoxylans are complex polymers (20,000-170,000 daltons) with a linear backbone of (1,4)-β-xylopiranosyl units to which substituents are attached through O2 and O3 atoms of the xylosil residues (mainly, α-L-arabinofuranosyl; Fincher and Stone, 1986). A high degree of arabinosylation will increase its water solubility and more than 20% of the water in wheat-flour dough is associated with arabinoxylans. This polymer is apparently linked to the cellulose skeleton in the corn cell wall by ester linkage cross-bonding through ferulic and diferulic acid.

Nixtamalized corn flour can contain from 7-9% of total dietary fiber and 6-8% mainly consists of insoluble fiber on a dry-weight basis (Sustain, 1997). Dietary fiber of the new generation can surpass the functional and sensory qualities of the standard dietary fibers (e.g., commercial source of wheat bran can be removed of its starch, gluten and phytic acid). Due to its new fiber structure and its capillary effect, the new fiber has good water binding capacity (twofold) and a positive effect on baked goods freshness (e.g., Vitacel-brand name).

Haarasilta et al. (U.S. Pat. No. 4,990,343), Baez Vasquez and Schoefield (1993) and Tanaka et al. (U.S. Pat. No. 5,698,245) have proposed that the use of endo and exo-hemicellulases causes decomposition of wheat insoluble fiber.

Fiber components of Corn Kernel Parts

| | % Dry | Insol. | Hemicel- | | | Soluble | Total | % Kernel |
|---|---|---|---|---|---|---|---|---|
| Part | matter | Fiber | lulose | Cellulose | Lignin | fiber | Fiber | fiber |
| Whole | 100 | 9.5 | 6.7 | 3 | 0.2 | 0.1 | 9.5 | 100 |
| Kernel | | | | | | | | |
| Starchy | 80.9 | 1.0 | — | — | — | 0.5 | 1.5 | 12 |
| Endo- | | | | | | | | |
| sperm | | | | | | | | |
| Aleurone | 2.0 | 50.0 | — | — | — | 25.0 | 75.0 | 15 |
| Endo- | | | | | | | | |
| sperm | | | | | | | | |
| Germ | 11.0 | 11.0 | 18 | 7 | 1.0 | 3.0 | 14.0 | 16 |
| Pericarp | 5.3 | 90.0 | 67 | 23 | 0.1 | 0.6 | 90.7 | 51 |
| (bran) | | | | | | | | |
| Tip cap | 0.8 | 95.0 | 70 | — | 2.0 | — | 95.0 | 6 |

Source: Watson, S. A. 1987, Structure and Composition, In Corn Chemistry and Technology.

Native cellulose and hemicellulose would render the dough non-homogeneous and affect the dough stretching capacity by preventing the formation of a gluten network (e.g., gliadin which provides elasticity and glutenin which effects viscosity). The enzyme treated bread product has an increased volume, more uniform grain structure, slower aging (retarded staling or retrogradation) and a reduction or replacement in baking additives. The benefit of using a xylanase instead of a traditional hemicellulase (pentosanase) preparation is that there are fewer side activities (e.g. α or β-amylase, β-xylosidase/glucosidase) in the xylanase product. A suitable level of enzymes results in a desirable dough softening without causing stickiness, thereby improving machinability.

Xylanolytic systems (Wong and Saddler, 1992) includes xylanases (1,4-β-D-xylan xylanohydrolase, EC 3,2,1,8) and β-xylosidases (1,4-β-D-xylan xylohydrolase, EC 3,2,1,37), the former generally hydrolyze the xylan backbone (endo-type) whereas the latter hydrolyze xylo-oligomers (exo-type). Xylose is not usually the major product and it is typically produced after xylobiose and xylotriose (smallest oligomer). Nonspecific xylanases from Trichoderma spp may attack cellulose and carboxymethylcellulose. Xylanases are classified into two major families (F or 10 and G or 11) of glycosylhydrolases. F10 xylanases are larger, more complex and produce low DP oligosaccharides (less specific); F11 are more specific for xylan (Jeffries, 1996). Low molecular weight xylanases (269-809 amino acid residues) were from B. Pumilus, B. Subtilis and C. Acetobutylicum (Wong and Saddler, 1992).

The xylanases can be prepared microbiologically by means of fungi and bacteria: A. Niger had shown not only arabinose releasing xylanase activity but also a xylotriose one, Trichoderma spp xylanases had optimal activity conditions between 45-65° C. and pH 3.5-6.5, Bacillus spp had alkaline tolerant (up to pH 10) and extreme thermophilic xylaneses; and a Thermostoga sp (strain FjSS3-B1) xylanase had a temperature optimum of 105° C. at pH 5.5 and a half-life of 90 min at 95° C.

In recent years there has been a growing interest in the use of xylanase enzymes in the paper, pulp (enhance beatability and binding ability), food and feed industries. The use of xylanases (with or without cellulase and pectinase) has been proposed for clarifying juices and wine, for extracting coffee, plant oils and “starch”, for improving the nutritional properties of agricultural silage, for macerating plant cell walls, for producing food thickeners and for providing “textures to bakery products”. The scope for new applications is restricted mainly by the limited availability of specific xylanases with the required purity, properties (i.e., pH optima and thermal stability) and action patterns as (endo or exo-hydrolytic mechanisms) Commercial xylanase preparations marketed for pulp treatment include Pulpzyme HA e(with little cellulolytic activity) from T. Reesei and Albazyme from T. Longibrachiatum. Crude enzyme preparations containing both hemicellulases and cellulases could be used to improve fibrillation and drainage properties of recycled pulpwood fibers (Wong and Saddler, 1992).

To aid in these developments, simple, reliable and sensitive procedures are required for the quantitative measurement of xylanase in a range of products with trace to high enzyme activity levels. The advent of genetic engineering has allowed the production of very specific enzyme preparations. A range of plant polysaccharides, including starch, β-glucan, arabinoxylan, fructans, as well as starch damage can be measured (McCleary, 1992).

Lopez-Munguia et al. (Mexican patent application 952,200) describes an enzymatic process to produce corn tortillas which retard accelerated staling with texture improvement during four days frozen storage. A fungal α-amylase blend (i.e., commercial enzymes from Novo, Gist Brocades and Genencor International) was added during rehydration of Maseca corn flour (0.01 U/kg), and modified the starch during tortilla cooking up to the denaturing temperature (Iturbe-Chinas et al., 1996).

### SUMMARY OF THE INVENTION

The present invention relates to a method of improving the Theological properties of corn masa dough and the properties of tortillas produced therefrom, by adding to the nixtamalized corn flour an effective amount of an enzyme component (or blend) containing hemicellulase and/or cellulase. A dough prepared with this flour premix will have advantageous rheological and handling properties and tolerance in a mechanized tortilla machine (Rodotec Ecologica-100; made by Tecnomaiz Gruma, Monterrey, N.L., Mexico). The final tortilla product will keep its flexibility and compressibility, even during extended commercial storage. The tortilla produced according to the invention therefore has less or no need of conventional antistaling additives.

The dough is produced by combining nixtamalized corn flour, water, and a hemicellulase and/or cellulase blend, with additives if desired, and mixing and kneading to form a suitable dough for a traditional as well as mechanized tortilla production. The invention also comprises a novel tortilla flour premix which includes corn masa flour, additives, and enzyme preparation with a suitable carrier directly incorpo- rated to the flour during its production.

Accordingly, the present invention provides a soft and cohesive dough without causing stickiness during tortilla manufacture. Another object is to provide a table tortilla with improved flexibility and rollability during commercial storage. The main object of the invention is the application of an enzyme blend comprising commercial hemicellulase and/or cellulase to improve not only the Theological properties of corn masa dough but also the flexibility of table tortillas. The baked product or corn tortilla is made by combining nixtamalized corn flour with a suitable amount of an enzyme preparation, additives and water and mixing and kneading to produce a soft and cohesive dough without excessive stickiness during mechanized tortilla production.

Preferably, the enzyme blend contains between 500 and about 5,000 Units of a commercial hemicellulase or about 500 to about 5,000 Units of cellulase per kilogram of corn flour. The tortilla flour premix preferably includes commercial antimicrobial additives (0.5-1% by weight) in combination with the enzyme blend before adding the premix directly to the flour in the production factory.

### DETAILED DESCRIPTION OF PREFERRED EMBODIMENTS

A tortilla can be defined as a flat, round, unfermented pancake produced from lime-cooked corn (Zea Mays L.). Three basic types of corn products are industrially manufactured: table tortilla, corn and tortilla chips. Many manufacturers use corn masa flour because it does not require much labor or equipment, and processors do not have to pay as much for effluent disposal and control of production practices.

The enzyme blend comprises about 500-5,000 Units per kilogram of corn flour, preferably calculated as xylanase units. A commercial preparation of fungal hemicellulase from A. Niger was kindly provided by Amano Pharmaceutical Co. and another multicomponent hemicellulase by Rhone-Poulenc (Rhodin) A crude cellulase preparation from T. Longibrachiatum (Fraction A; mainly with endoxylanase and cellulase activities) was obtained from Biotechnology Center (ITESM, Monterrey, N.L., Mexico: Baez-Vasquez and Schoefield, 1993).

The definitions of the different enzyme activities are defined below:

Xylanase activity (Megazyme International Ireland, Ltd, Ireland). A modified Somogyi-Nelson reducing sugar assay for the measurement of β-xylanase using Wheat Arabinoxylan as substrate (Megazyme assay procedures XYL 9/95:14-45). One unit is the amount of enzyme which produces one micromole of xylose per minute at pH 4.7 and 40° C. (Fraction A: test result 1,400 micromoles-xylose/min-g). The major advantages of this procedure are that the color response with oligosaccharides of increasing degree of polymerization is stoichiometric; and the assay is very sensitive (10-50 μg).

Rhodia-Rhone Poulenc reported a minimum xylanase activity (multicomponent hemicellulase) of 4,000 U/gram (4,000 mg-maltose/min-g) or reducing sugar equivalent to 5,850 μmoles-glucose/min-g (DNS assay).

Hemicellulase activity (Amano-Enzyme USA Co., Ltd.). A Somogyi-Nelson assay was used and one unit is the amount of enzyme which produces reducing sugar equivalent to ten micrograms of xylose per minute at pH 4.5 and 40° C. (Amano-90; test result 109,000 U/gram or 7,270 micromoles-xylose/min-g).

The enzyme preparation may contain xylanase activity functioning both with endo- and exo-mechanisms. They may also contain the following enzyme side-activities: (α-amylase (Amano-90), β-xylosidase (Amano-90) and β-glucosidase (Fraction A and Amano-90).

### EXAMPLE 1

Preparation of a Traditional-style Corn Tortilla, Showing the Effect of the Enzyme Blend on Tortilla Texture

A shelf-life study was designed with laboratory corn tortillas stored at room temperature and their flexibility and compressibility changes were recorded, simulating seven days storage.

Commercial enzymes were used (Amano-90:code AM-blend from A. Niger, and Rhodia-Rhone Poulenc code RP-blend) as well as a crude cellulase extract from Trichoderia longibrachiatum (Fraction A: code A-blend from Biotechnology Center-ITESM). Three enzyme formulations in corn flour were tested: formulation 1 (0 U/k or control), formulation 2 (500 U/k) and formulation 3 (5000 U/k).

All treatments used nixtamalized corn flour (commercially available type) and a fine dough (corn masa) was manually prepared by rehydration of flour with warm water (30° C.) in a 1:1.25 ratio, and adding a liquid antimicrobial additive (1% based on flour; Kemin brand). In experiments including enzymes, the appropriate enzyme activity of flour was dissolved in the warm water with additive and manually kneaded during one minute. The dough temperature was about 28° C. and doughballs were manually divided and weighed (25 grams each). Doughballs were plated flat with a manual tortilla machine (Productos Practicos, S.A.) for controlling disk thickness around 0.2-0-3 cm (80-125 mils). Flat dough disks were cooked on a hot plate (185° C.) and after 15 s the tortilla is turned to cook the other face. The exposed side heats up after another 15 s and finally the tortilla is turned again during 15 s until the vapor produced makes it swell. After cooling the tortillas (0.2 cm or 80 mils thick) at room temperature they were packaged in polyethylene bags and sealed for storage.

To evaluate the flexibility effect of all the treatments, tortillas were reheated on a hot plate for 20 s and cooled for five minutes before texture analysis. The flexibility measurement used stainless-steel rods of several diameters (0.5 to 3 cm) and rolling the warmed tortilla in a decreasing size order, recording the rod number at which the tortilla sample just breaks when it is flexed (U.S. Pat. No. 3,730,732). A more flexible tortilla will just break when it is bent around a smaller rod diameter than a less flexible one. A compressibility test used a procedure which measured the relative distance when compressing three stored tortillas with a standard weight. This compression test is an uniaxial deformation of a solid food under a constant force and it estimates an instantaneous elastic tortilla deformation. An indirect rollability test consisted of rolling the warmed tortilla as a cylinder and then recording its average diameter with a Vernier without breaking the warmed tortilla.

The laboratory results of enzymatic treatments were as follows:

| Corn tortilla texture: | Formula (3 = 5,000, 2 = 500, 1 = 0 U/k): | |
|---|---|---|
| Flexibility | 1-day | 3 > 2 > 1 |
| | 7-days | 3 > 2 > 1 |
| Compressibility (elasticity) | 1-day | 3 > 2 > 1 |
| | 6-days | 3 > 2 > 1 |
| Rollability | After | 1 > 3 = 2 |
| | 6-days | |
| Moisture content (%) | 7-days | 3 = 2 > 1 |

The tortilla treatments to which a high dosage of the enzyme blend (AM and RP & 5000 U/k) has been added were excellent in the standard laboratory evaluations in comparison with the control and enzyme A treatments. A low enzyme and specific activity in the crude extract A-blend, as compared to the commercial enzymes, might have caused a low effect during tortilla storage.

Due to the addition of commercial enzymes during hydration of nixtamalized corn flour and dough kneading, flexibility, compressibility and rollability of the tortillas were improved. The activities of the arabinoxylan-depolymerizing enzymes (hemicellulases) of insoluble corn-pericarp can be relatively low; nevertheless, they are believed to have a favorable impact on the tortillas due to rendering them more soluble—with higher water binding capacity—and a tendency to be softer (less elastic than the control tortilla).

The traditional-style tortilla is usually produced without additional use of emulsifiers and gums, and therefore usually has a limited shelf-life because of microbial spoilage and staling. It is believed that hardening or loss of flexibility (35% after 4 days at room temperature), is caused by starch retrogradation. The addition of edible water soluble alkaline materials (1%) to the corn dough markedly increased the yield of dough (2.29) and tortilla (1.81) per kilogram of limed corn flour (U.S. Pat. No. 3,730,732).

Thus a soluble corn-pericarp may impart not only water binding capacity, but also cohesivity and plasticity to corn dough for traditional tortilla making. A corn masa dough model can be described as a plastic, cohesive, smooth mixture of large pieces of endosperm bound by a colloidal dispersion (5-9% of total dough). This glue-like dispersion is made of soluble starch, protein and non-starch polysaccharides which form a hydrated matrix where endosperm particles are suspended.

### EXAMPLE 2

Preparation of Mechanized Tortillas, Showing the Effect of the Enzyme Blend on Corn Dough and Tortillas Made Therefrom.

A shelf-life test was performed on mechanized tortillas stored at room temperature, with standard laboratory evaluations made during their seven-day storage. Corn dough measurements before tortilla making included consistency (degree of resistance to penetration or firmness: Universal Penetrometer, Precision Scientific, Inc.) and adhesivity (ratio of adhesion breaking stress to cohesion breaking stress: U.S. Pat. No. 3,788,139). Plastic doughs which are soft and adhesive can be measured, thus making possible to determine the adhesion when the cohesion is known. Tortilla texture tests during storage comprised flexibility (resistance to bending with a method used in U.S. Pat. No. 3,730,732) and compressibility (resistance to compression with the same method as in Example 1). A higher flexibility index corresponds to rods of lower radii and indicates higher tortilla flexibility.

Mechanized tortilla pilot tests were carried out by adding to nixtamalized corn flour (commercially available type) a commercial water-soluble gum additive and two commercial enzyme blends: Formulation 1 (Control), Formulation 2 (Carboxymethylcellulose Sodium-Amtex, 2500 ppm), Formulation 3 (Amano-90, 500 U/k as recommended) and Formulation 4 (Hemicellulase-Rhodia, 5000 U/k).

The corn dough was mechanically made as follows: the corn masa flour and dry additives were mixed for 5 minutes (Dough mixer, tecnomaiz-Gruma), warm potable water was added (1.2:1 ratio at 30° C.) with an antimicrobial additive (0.8% Kemin, based on flour) and the resulting corn dough was kneaded for 5 minutes.

Thereafter, the corn dough was moved and placed in a feeder-sheeting-former-oven machine (Rodotee Ecologica-100, Tecnomaiz-Grauma, Monterrey, N.L. Mexico). A feed screw moves the dough horizontally into a manifold which pushes it through a slot. The plastic dough is fed onto a pair of smooth rollers, one rotating counterclockwise and the other clockwise. The gap between the rollers is adjustable and the thickness of the dough sheet determines the final product weight and its diameter.

The flat disks of dough pieces leave the front roller on a discharge belt, which feeds directly into the oven. A natural gas-fired oven is used to bake sheeted dough into tortillas. They are baked at temperatures ranging from 300° C. to 330° C. in a multiple-pass three-tier oven in which the residence time varies from 20-40 seconds. After cooling the tortillas (0.18 cm or 61-74 mils-thickness) at room temperature, they were packaged in polyethylene bags and sealed for storage.

Prior to kneading, the enzyme composition can be mixed with a portion of the total amount of corn flour to form a so-called tortilla pre-mixture. This pre-mixture can be added at the beginning of dough mixing in controlled dosages per kilogram of corn flour (Amano-90, 500 U/k and Hemicellulase-Rhodia, 5000 U/k). The carrier in the pre-mixture can also be other ingredients than corn flour, such as an anticaking agent or an additive mixture containing ingredients and conventional additives. Dough made with enzyme formulation gave the following results:

| Corn dough machinability: | | Formulation treatments: |
|---|---|---|
| Consistency (firmness) | 0-day | 1 > 2 > 4 = 3 |
| | | 148 to 165 |
| Adhesivity (stickiness) | 0-day | 4 = 3 > 2 = 1 |
| | | 0.4 to 0.6 |
| Moisture content (%) | 0-day | 4 = 3 = 2 = 1 |
| | | 58 to 59 |
| Surface roughness | 0-day | 4 = 3 = 1 > 2 |
| Moisture baking loss (%) | | 4 = 3 > 1 > 2 |
| | | 17 to 20 |
| Baking swelling (%) | 0-day | 2 > 4 > 1 = 3 |
| | | 75 to 89 |

Pilot-scale results from the tortilla making showed that the corn dough prepared with the addition of an enzyme composition was less firm and less cohesive after kneading than the conventional CMC and control dough. A similar moisture content among treatments indicated a more adhesive (but non-sticky) corn dough with enzyme blend as compared to the commercial CMC and control. Enzyme (AM) treatment of corn dough (at a constant moisture content) with an excess level of hemicellulase activity resulted in a rapid loss of dough strength (less cohesive) and production of a wet, sticky dough mass.

The addition of enzyme blends acts to increase the yield of corn dough per kilogram of corn flour, and the total amount of water used to make a standard consistency dough (regular type) is lower than if the additives were not employed. A higher dough consistency is proportional to its viscosity and to cohesive dough strength which holds the viscoelastic food under stress during tortilla making.

A low moisture content composition may result in a machinable (firm), cohesive (viscous) and non-sticky corn dough needed to shape flat disks into thin and rollable tortillas with a potential in reducing energy baking cost. Weak corn flours tend to give sticky doughs that hang up in the equipment with little cohesivity with which to bear its own weight if it is to form a sheet dough and not to break apart.

Corn masa dough texture is determined by factors such as maize variety, endosperm texture, drying conditions, as well as the water uptake and degree of starch gelatinization during corn cooking and grinding operations. During alkali-cooking, chemical and physical changes, such as gelatinization and partial removal of the germ and pericarp, occur in the corn kernel. During the formation of corn dough, grinding disrupts the swollen gelatinized starch granules and distributes the hydrated starch and protein around the ungelatinized portion of the corn endosperm.

Therefore a knowledge of corn flour characteristics as well as interactions among their components and other dough ingredients can be improved by understanding their critical properties. An evaluation of physicochemical and Theological properties of corn products has been a valuable tool for describing and predicting the quality of raw materials, intermediate and final products in processes. Objective tests which best predict the tortilla and snack making quality of U.S. and Mexican corn masa flours were particle size distribution, water uptake (dough yield), pH color and amylograph peak viscosity.

Differences observed during the baking process in the corn dough properties manifested themselves in the final mechanized tortilla product (50 tortillas per minute):

| Corn tortilla texture: | | Formulation treatments: |
|---|---|---|
| Flexibility (rollability) | 7-days | 4 = 3 > 2 > 1 |
| | | 3 to 4.5 |
| Compressibility (%) | 7-days | 4 = 3 > 2 > 1 |
| | | 8 to 12 |
| Moisture content (%) | 7-days | 4 = 3 = 2 = 1 |
| | | 46 to 47 |
| Thickness (mils) | 7-days | 4 = 3 > 2 > 1 |
| | | 70 to 74 |

The pilot-scale tortillas showed that by means of the enzyme blend the machinability of the doughs could be improved with the exception of a rough tortilla surface as compared to the conventional CMC additive (water-soluble gum) used in commercial mechanized production (600 or 900 tortillas per minute).

The new enzyme additive (AM at 500 U/k or RP at 5000 U/k) imparts the property of retarding the loss of flexibility and compressibility during a seven-day storage time. Thus, packaged tortillas with antimicrobial additive and stored at room temperature in which no moisture is lost from them become hard or stale more slowly because of the enzyme blend, which increases the flexible shelf-life and the freshness of stored and also reheated tortillas.

The nixtamalized corn flour used in this invention (regular brand) can contain coarse, intermediate and fine particles. The large ones are pieces of remnant pericarp, peripheral endosperm and germ. The medium and small particles are mostly endosperm and germ pieces. Thus, particle size distribution and moisture content in the formulation affect directly not only the physical-rheological properties of corn dough but also its machinability during tortilla making. A corn pericarp may contain a 50% hemicellulose content and when it is extracted, yields from 30 to 45% have been reported. This corn-fiber hemicellulose, commonly referred to as corn fiber gum (in dry and wet milling processes) has new functional properties as an adhesive, thickener, stabilizer and antistaling additive in baked wheat products.

A partial enzymatic and acidic hydrolysis of corn pericarp yielded oligosaccharide fragments rendering the insoluble dietary fiber into a soluble fiber which may develop an increased hydrated mass dough matrix, during mechanical kneading, with better tolerance to dough sheeting and forming in mechanized tortilla making. The effective amount of hemicellulose and cellulose degrading enzymes is mutually dependent on the activities of each other. Furthermore, the levels may also be dependent on the microbial source (fungal or bacterial) used in industrial enzyme production and purification processes.

The enzyme blend additive of the present invention has the property of retarding loss of flexibility which is promoted by storing under refrigeration and freezing temperatures. Another conventional additive used in the corn masa dough has the capacity to retard microbial spoilage up to seven-day tortilla storage.

While the present invention has been described above in connection with several preferred embodiments, it is to be expressly understood that those embodiments are solely for illustrating the invention, and are not to be construed in a limiting sense. After reading this disclosure, those skilled in this art will readily envision insubstantial modifications and substitutions of equivalent materials and techniques, and all such modifications and substitutions are considered to fall within the true scope of the appended claims.

### References

| | |
|---|---|
| U.S. Pat. No. 3,730,732 | 1973 Rubio M. J. |
| U.S. Pat. No. 3,788,139 | 1974 Rubio M. J. and Leal V. M. |
| U.S. Pat. No. 4,513,018 | 1985 Rubio M. J. |
| U.S. Pat. No. 4,990,343 | 1991 Haarasilta et al. |
| U.S. Pat. No. 5,698,245 | 1997 Tanaka et al. |
| U.S. Pat. No. 6,066,356 | 2000 Van der Wouw et al. |

Mexican Patent Application 952,200, 1995 Lopez-Mungula

Baez-Vasquez, M. A. and Schoefield, J. D., 1993, Bread improving effect of an endo-xylanase of Trichoderma longibrachiatum in the Chorleywood bread making process (CBP) (abstr.), Cereal Foods World, 38:635.

Fincher, G. B. and Stone, B. A. 1986, Cells walls and their components in cereal grain technology. In: Advances in Cereal Science and Technology, Ed. Y. Pomeranz, AACC, St. Paul, Minn. USA. Vol 8:207-295.

Iturbe-Chinas, F. A., Lucio-Aguerreber, R. M., and Lopez-Munguia, A. 1996. Shelf-life of tortilla extended with fungal amylases. International Journal of Food Science and Technology, 31:505-509.

Jeffries, T. W. 1996. Biochemistry and genetics of microbial xylanases. Current Opinion in Biotech. 7:337-342.

McCleary, B. V. 1992. Measurement of endo-1,4-β-D-Xylanese, in: Xylans and Xylanases Eds. J. Visser, G. Beldman, M. A. Kusters-van Sorneren and A. G. J. Voragen. Elsevier Science Publishers, Amsterdam, Holland. pp: 161-169.

Montemayor E. and Rubio, M. 1983. Alkaline cooked flour: Technology and use in tortilla and snack products (abstr) Cereal Foods World 28:577.

Ramirez, J. F. and Alvarez, M. M. 1995. Biodegradative Treatment of Nixtamalization Waters (Nejayote). Abstract in Keystone Symposia of Environmental Biotechnology (Journal of Cellular Biochemistry), Silverstone, Col. USA.

Sustain, 1997. A Literature and Industry Experience Review, In: Fortification of corn masa flour with Iron and/or Other Nutrients, By: Bressani, R., Rooney, L. W. and Serna-Saldivar, S. O. USAID, Washington, D.C. December (165p).

Watson, S. A. 1987, Structure and Composition, In: Corn Chemistry and Technology Eds. S. A. Watson and P. E. Ramsted. AACC, St. Paul, Minn. USA, pp:53-78.

Wong, K. K. Y. and Saddler J. N. 1992. Trichoderma xylanases, their properties and application, In: Xylanes annd Xylanases Eds. J. Visser, G. Beldman, M. A. Kusters-van Sorneren and A. G. J. Voragen. Elsevier Science Publishers, Amsterdam, Holland. pp: 171-181.

We claim:

1. A method of making a corn masa dough that produces corn tortillas having improved storage stability, comprising combining nixtamalized corn flour and water with an effective amount of an enzyme component containing at least one of hemicellulase and cellulase, and mixing the corn flour, water and enzyme component to form a corn masa dough.

2. The method of claim 1 wherein the effective amount is from about 500 to about 5000 Units of said enzyme component per kilogram of corn masa flour.

3. The method of claim 2 wherein enzyme activity of said enzyme component is expressed as activity of xylose or reducing sugar producing enzyme per kilogram of corn masa flour.

4. The method of claim 1, wherein said corn masa dough is prepared manually.

5. The method of claim 1, wherein said corn masa dough is prepared mechanically.

6. The method of claim 4 wherein said dough further comprises an antimicrobial additive in an amount of about 0.5% to about 1% by weight.

7. The method of claim 6 wherein said enzyme component is embodied as a tortilla flour premix including corn masa flour, additives, and said enzymes.

8. The method of claim 5 wherein said dough further comprises an antimicrobial additive in an amount of about 0.5% to about 1% by weight.

9. The method of claim 8 wherein said enzyme component is embodied as a tortilla flour premix including corn masa flour, additives, and said enzymes.
